(19) United States
(12) Patent Application Publication
(10) Pub. No.: US 2013/0191011 A1
(43) Pub. Date: Jul. 25, 2013

(54) METHOD FOR CONTROLLING A VEHICLE ENGINE

(71) Applicants: Glen R. Macfarlane, Howell, MI (US); Brian E. Beechie, Armada, MI (US); Fadi S. Kanafani, Windsor (CA)

(72) Inventors: Glen R. Macfarlane, Howell, MI (US); Brian E. Beechie, Armada, MI (US); Fadi S. Kanafani, Windsor (CA)

(21) Appl. No.: 13/740,355

(22) Filed: Jan. 14, 2013

Related U.S. Application Data
(60) Provisional application No. 61/589,984, filed on Jan. 24, 2012.

(51) Int. Cl. F02D 35/02

(52) U.S. Cl. CPC F02D 35/02
USPC 701/110

(57) ABSTRACT

A method and apparatus for controlling a vehicle engine during conditions detrimental to the engine such as e.g., high engine speed with high oil temperature and/or low oil pressure. In addition to protecting the engine, the method and apparatus will also improve the vehicle's fuel economy.

### CROSS REFERENCE TO RELATED APPLICATION

This application claims the benefit of U.S. Provisional Ser. No. 61/589,984, filed Jan. 24, 2012.

### FIELD

The present disclosure relates to engine speed control for a vehicle, particularly to a method and apparatus implementing an oil temperature/oil pressure engine speed limit control feature for a vehicle.

### BACKGROUND

Engine oil and oil pressure are essential factors in preventing degradation to a vehicle's engine. Oil pressure circulates the engine oil through the engine to provide lubrication to key components such as e.g., the connecting rod, bearings, camshaft, lobes and cylinder walls. Lubrication reduces friction by keeping the metal components from touching each other. Proper lubrication will also cool down the components and help prevent the components from wearing down. Poor oil pressure may lead to poor lubrication, over heating of engine components, and eventually undesirable engine component degradation.

As shown in FIG. 1, oil pressure is higher when the engine and oil are cool due to an increased viscosity of the oil. As can be seen, when the engine and oil are cool, the oil pressure will increase as the engine speed increases. Engine oil generally gets thinner as it warms up. Thus, as shown in FIG. 1, engine oil pressure decreases with increasing engine oil temperature. Problems arise if the oil pressure falls below the minimum required oil pressure for maintaining the life of the engine components. FIG. 1 illustrates a minimum required oil pressure curve for e.g., connecting rod bearings. Engine components, and the engine itself, may become damaged if the oil pressure drops below the curve, particularly while the engine speed is above mid-speed.

Today's vehicles often use oil coolers to reduce the temperature of the circulating oil. Unfortunately, it is still possible for the oil to heat up and the pressure to drop below an acceptable level at high engine speeds. Other vehicles use large oil pumps to maintain a suitable oil pressure at high speeds. Large pumps, however, penalize vehicle fuel economy. In addition, the engine can still be damaged if there is pump failure or other failure that allows the vehicle to be driven with undesirable low oil pressure at high RPM (revolutions per minute).

Accordingly, there is a need and desire for a method and apparatus for determining when the condition of the engine oil (i.e., oil temperature/pressure) is detrimental to the vehicle's engine and for implementing countermeasures to avoid damage to the engine.

### SUMMARY

In one form, the present disclosure provides a method of detecting and modifying an engine oil condition that may cause undesirable engine degradation in a vehicle. The method comprises determining that the engine oil condition may be detrimental at a current engine speed; and reducing the engine speed by a predetermined amount if it is determined that the engine oil condition may be detrimental at the current engine speed.

The present disclosure also provides an apparatus for detecting and modifying an engine oil condition that may cause engine detrimental degradation in a vehicle. The apparatus comprises an engine controller adapted to: determine that an engine oil condition may be detrimental at the current engine speed; and reduce the engine speed by a predetermined amount if it is determined that the engine oil condition may be detrimental at the current engine speed.

In one form, the oil condition is high oil temperature and the engine speed is reduced by a predetermined amount based on the temperature of the oil.

In another form, the oil condition is low oil pressure and the engine speed is reduced by a predetermined amount based on the oil pressure.

In yet another form, reducing the engine speed comprises determining a redline RPM offset based on the oil temperature and subtracting the redline RPM offset from a redline RPM limit for the engine. In another form, reducing the engine speed comprises determining a new redline RPM limit for the engine based on the oil temperature.

In yet another form, reducing the engine speed comprises determining a redline RPM offset based on the oil pressure and subtracting the redline RPM offset from a redline RPM limit for the engine. In another form, reducing the engine speed comprises determining a new redline RPM limit for the engine based on the oil pressure.

Further areas of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is an example graph of engine oil pressure vs. engine speed;

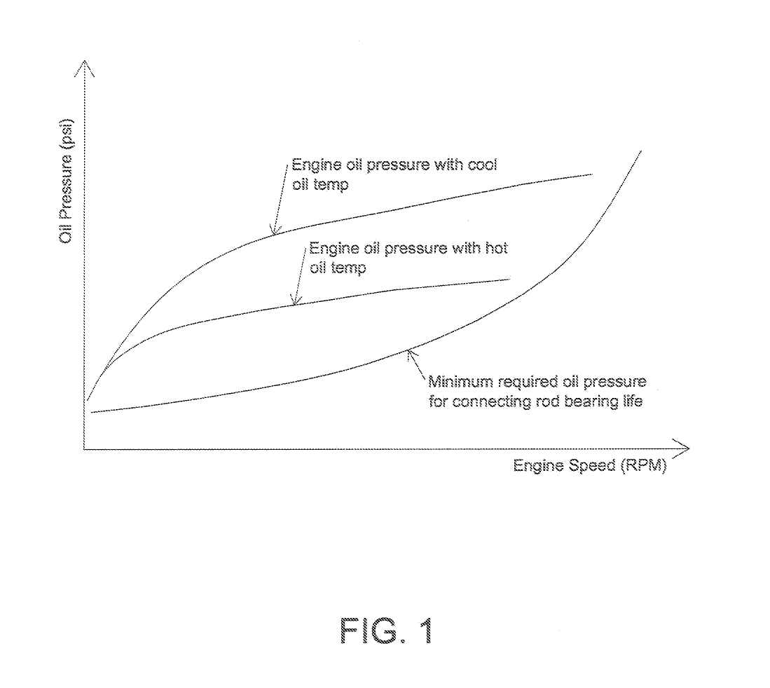

FIG. 2 is a flowchart of a method of determining that the condition of the engine oil is detrimental to the vehicle's engine and for implementing countermeasures to avoid damage to the engine in accordance with an embodiment disclosed herein;

FIG. 3 is a flowchart of another method of determining that the condition of the engine oil is detrimental to the vehicle's engine and for implementing countermeasures to avoid damage to the engine in accordance with another embodiment disclosed herein;

FIG. 4 is a block diagram of an apparatus in accordance with an embodiment disclosed herein for performing the methods of FIGS. 2 and 3; and

FIG. 5 is an example graph of engine oil pressure and engine power vs. engine speed.

### DETAILED DESCRIPTION

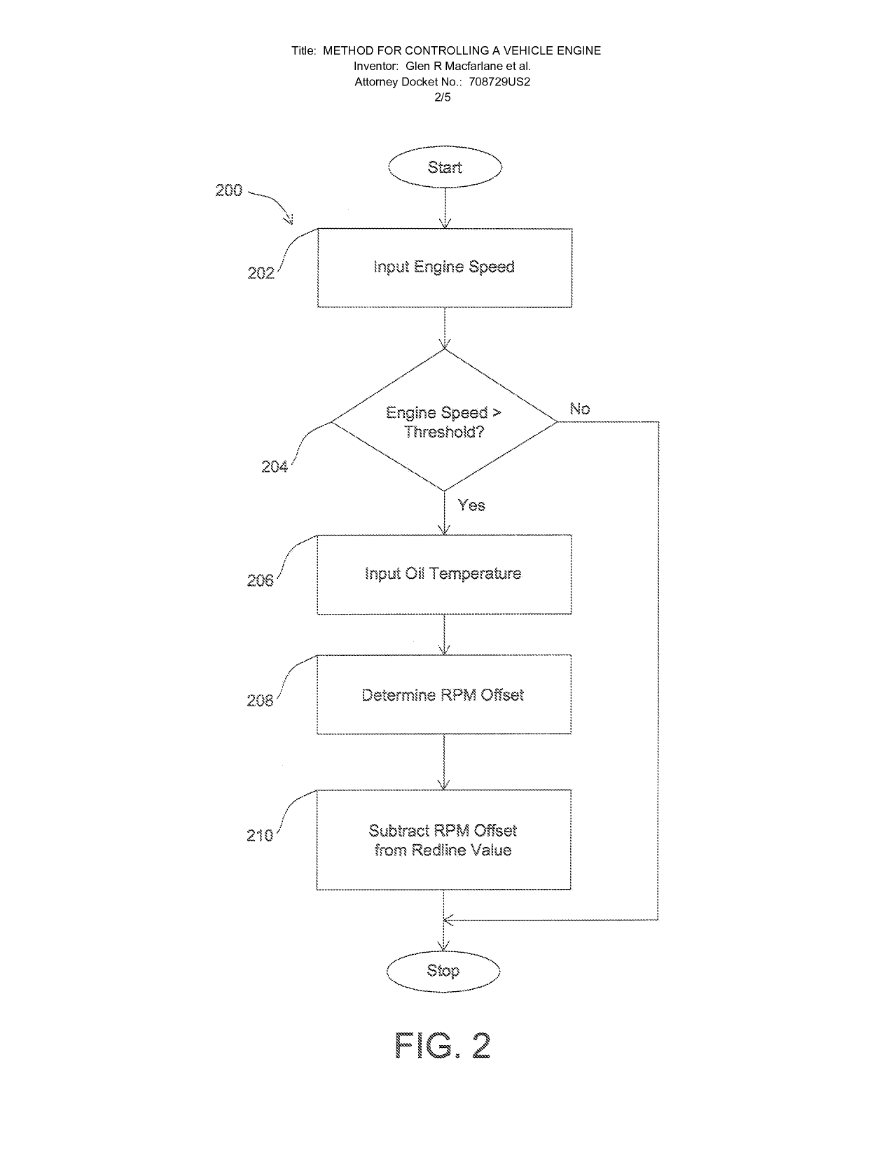

FIG. 2 illustrates a first method 200 of determining that the condition of the engine oil is detrimental to the vehicle's engine and for implementing countermeasures to avoid possible detrimental degradation to the engine. As will become apparent, the countermeasures include modifying, e.g. reducing, the engine's speed by e.g., reducing the engine's redline RPM limit. Reducing the redline RPM limit will cause a limiter to prevent the engine from exceeding a limit or to slow down the engine until the engine RPM drops below the limit. The operation of redline/rev limiters is known and is not discussed further. Reducing the engine speed in this manner is a non-intrusive way to allow the oil pressure to remain at a desirable level for the engine speed, avoiding detrimental degradation to the engine or a component thereof. It should be noted that the disclosed embodiments should not be limited solely to reducing the redline RPM limit. In fact, the engine's speed can be reduced by any means including e.g., a fuel cut-off, electronic throttle, or any other suitable mechanism. The reduction in the redline RPM limit, however, is desired since it is non-intrusive and simple to implement.

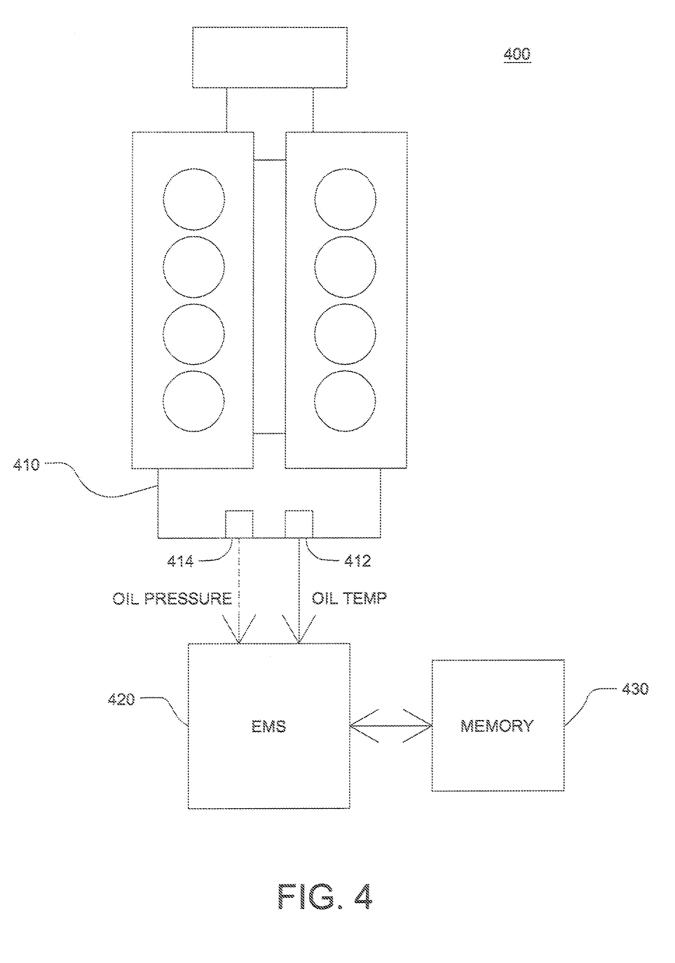

The method 200 inputs the engine speed at step 202. Step 204 determines if the engine speed is high enough that high oil temperature could cause undesirable degradation to the engine, for example a component and fluid (e.g. the engine oil) of the engine. If the engine speed is not above the threshold, then the engine is not in danger and there is no reason to continue method 200 at this point. Accordingly, if at step 204 it is determined that the engine speed is not above a predetermined RPM threshold, the method 200 terminates because there is no danger to the engine at this point. However, if at step 204 it is determined that the engine speed is above the predetermined threshold, the method 200 continues at step 206, where the oil temperature is input. As discussed below with reference to FIG. 4, the oil temperature may be received from a temperature sensor 412 installed in the engine. It should be appreciated that steps 202 and 204 could be skipped and the rest of method 200 can be executed regardless of the engine speed, if desired.

As step 208, the input oil temperature is used as an index into a redline RPM offset table such as example Table 1 illustrated below. The table may be populated based on known engine statistics or by a calibration process and may contain as many entries deemed suitable for success of the method 200. Thus, at step 208, an RPM offset value is selected from the table based on the input oil temperature. As can be seen in example Table 1, the offset gets larger as the engine oil temperature increases because the oil pressure is dropping and most likely approaching the minimum required pressure discussed above for maintaining a desirable life of the engine components.

TABLE 1

| Oil Temperature | |
|---|---|
| (Celsius) | RPM Offset |
| 120 | 0 |
| 130 | 200 |
| 140 | 800 |
| 150 | 1200 |

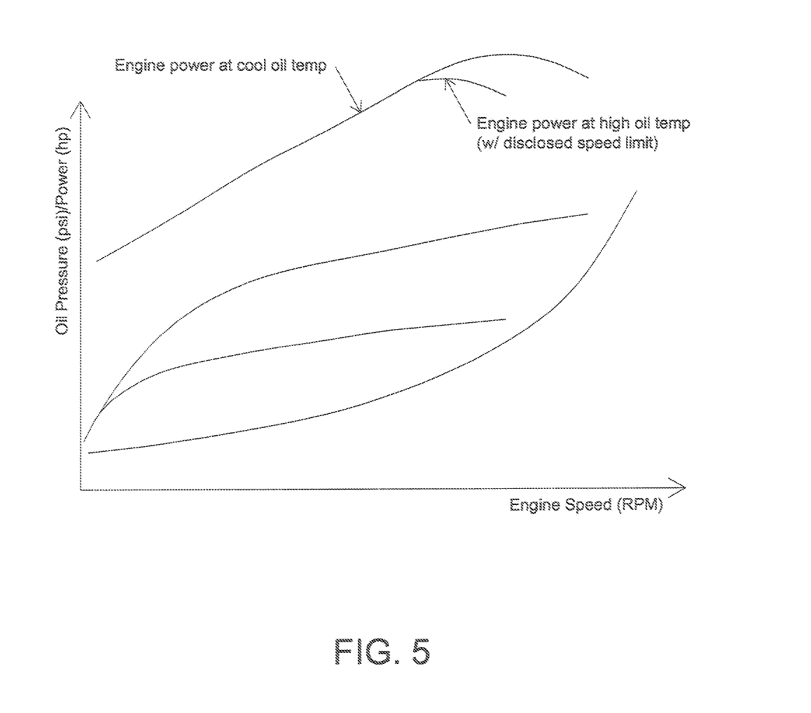

At step 210, the redline RPM offset is subtracted from the standard redline RPM limit. The vehicle's redline/rev limiter will slow down the engine speed (by any suitable mechanism) if the engine speed is above the new redline RPM limit. FIG. 5 illustrates engine power vs. engine speed when the oil temperature is cool. The power curve for cool oil temperature is not effected by the method 200. The power curve for high/hot oil temperature is effected by the method 200. As can be seen, the power curve for high/hot oil temperature has less power at higher RPM and is stopped well before the higher RPM (reachable previously). With a reduced speed, the engine is no longer at risk of degradation even though the oil temperature is still high.

It should be appreciated that the method 200 could retrieve a direct RPM limit based on the oil temperature at step 208 instead of the RPM offset. That is, the oil temperature (step 206) could index an RPM limit table such as example Table 2 shown below. The retrieved RPM limit would then become the new redline RPM limit for the limiter. Retrieving a direct RPM limit instead of the RPM offset dispenses with subtracting step 210.

TABLE 2

| Oil Temperature | |
|---|---|
| (Celsius) | RPM Limit |
| 120 | 6000 |
| 130 | 5800 |
| 140 | 5200 |
| 150 | 4800 |

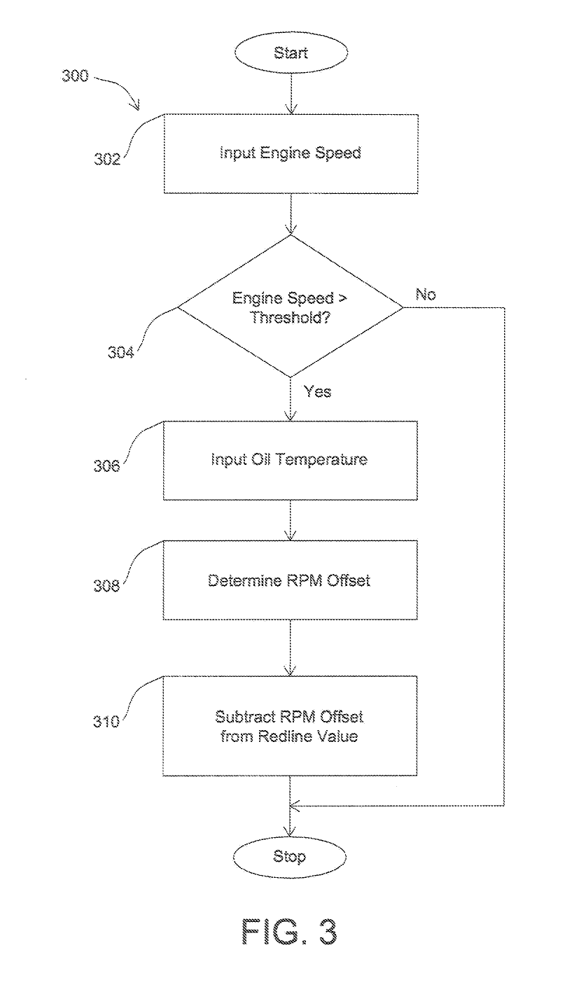

FIG. 3 illustrates another method 300 of determining that the condition of the engine oil is detrimental to the vehicle's engine and for implementing countermeasures to avoid undesirable degradation to the engine. Method 300 will also be described as reducing the engine's speed by reducing the engine's redline RPM limit. As with method 200, method 300 could reduce engine speed by any method discussed above and should not be limited solely to reducing the redline RPM limit.

The method 300 inputs the engine speed at step 302. Step 304 determines if the engine speed is high enough that poor oil pressure could cause undesirable degradation of an engine component. If the engine speed is not above the threshold, then the engine is not in danger and there is no reason to continue method 300 at this point. Accordingly, if at step 304 it is determined that the engine speed is not above a predetermined RPM threshold, the method 300 terminates because there is no danger to the engine at this point. However, if at step 304 it is determined that the engine speed is above the predetermined threshold, the method 300 continues at step 306, where the oil pressure is input. As discussed below with reference to FIG. 4, the oil pressure may be received from a pressure sensor 414 installed in the engine. It should be appreciated that steps 302 and 304 could be skipped and the rest of method 300 can be executed regardless of the engine speed, if desired.

As step 308, the input oil pressure is used as an index into a redline RPM offset table such as example Table 3 illustrated below. Thus, at step 308, an RPM offset value is selected from the table based on the input oil pressure. As can be seen in example Table 3, the offset gets larger as the engine oil pressure drops and approaches the minimum required pressure discussed above.

TABLE 3

| Oil Pressure | |
|---|---|
| (psi) | RPM Offset |
| 60 | 0 |
| 55 | 200 |
| 50 | 800 |
| 45 | 1200 |

At step 310, the redline RPM offset is subtracted from the standard redline RPM limit. The vehicle's redline/rev limiter will slow down the engine speed (by any suitable mechanism) if the engine speed is above the new redline RPM limit. With a reduced speed, the engine is no longer at risk of damage. It should be appreciated that the power curves illustrated in FIG. 5 will also apply for method 300.

It should be appreciated that the method 300 could retrieve a direct RPM limit based on the oil pressure at step 308 instead of the RPM offset. That is, the oil pressure (step 306) could index an RPM limit table such as example Table 4 shown below. The retrieved RPM limit would then become the new redline RPM limit for the limiter. Retrieving a direct RPM limit instead of the RPM offset dispenses with subtracting step 310.

TABLE 4

| Oil Pressure | |
|---|---|
| (psi) | RPM Limit |
| 60 | 6000 |
| 55 | 5800 |
| 50 | 5200 |
| 45 | 4800 |

In a desired embodiment, the methods 200, 300 are implemented in software, stored in a computer readable medium (e.g., memory device 430 illustrated in FIG. 4, which could be a random access memory (RAM) device, non-volatile random access memory (NVRAM) device, or a read-only memory (ROM) device) and executed by a processor included in an engine controller or engine management system (EMS) 420 illustrated in FIG. 4. The methods 200, 300 can be executed periodically, at a predetermined rate deemed suitable for success, as part of the engine management system's 420 normal operating processing or background processing.

FIG. 4 illustrates a vehicle apparatus 400 having the EMS 420 for implementing the methods 200, 300 discussed above. The EMS 420 includes a programmed processor or controller for implementing the methods 200, 300 and has, or is connected to, the memory device 430. The memory 430 may be used to store the redline RPM offset tables required by the methods 200, 300. The EMS 420 is connected to an oil temperature sensor 412 connected to the engine 410. The oil temperature sensor 412 is used to input the oil temperature used in method 200. Alternatively, or in addition to, the EMS 420 may be connected to an oil pressure sensor 412 connected to the engine 410. The oil pressure sensor 414 is used to input the oil pressure used in method 300. Although not shown, the EMS 420 will also input engine speed via a sensor from the engine 400.

The disclosed embodiments provide several benefits. First, proper and safe oil pressure for the engine speed (even at high RPM) is insured. The techniques disclosed herein can be implemented quickly, inexpensively and without additional engine components (other than an oil pressure sensor, if desired). The disclosed techniques do not require large oil pumps, which will improve the vehicle's fuel economy compared with vehicles having the larger pumps. The disclosed techniques do not impede on existing trailer tow ability while protecting the engine at high RPM and oil temperature. Moreover, it may be possible to remove the oil cooler in some vehicles, simplifying and reducing the cost of the vehicle's lubrication system.

What is claimed is:

1. A method of detecting and modifying an engine oil condition in a vehicle, said method comprising:
determining that the engine oil condition may be detrimental at a current engine speed; and
reducing the engine speed by a predetermined amount if it is determined that the engine oil condition may be detrimental at the current engine speed.

2. The method of claim 1, wherein the oil condition is high oil temperature.

3. The method of claim 2, wherein the engine speed is reduced by a predetermined amount based on the temperature of the oil.

4. The method of claim 2, wherein the step of reducing the engine speed comprises:
determining a redline RPM offset based on the oil temperature; and
subtracting the redline RPM offset from a redline RPM limit for the engine.

5. The method of claim 2, wherein the step of reducing the engine speed comprises determining a new redline RPM limit for the engine based on the oil temperature.

6. The method of claim 1, wherein the oil condition is low oil pressure.

7. The method of claim 6, wherein the engine speed is reduced by a predetermined amount based on the oil pressure.

8. The method of claim 6, wherein the step of reducing the engine speed comprises:
determining a redline RPM offset based on the oil pressure; and
subtracting the redline RPM offset from a redline RPM limit for the engine.

9. The method of claim 6, wherein the step of reducing the engine speed comprises determining a new redline RPM limit for the engine based on the oil pressure.

10. The method of claim 1, wherein reducing the engine speed comprises adjusting an electronic throttle.

11. The method of claim 1, wherein reducing the engine speed comprises cutting off fuel to the engine.

12. An apparatus for detecting and modifying an engine oil condition in a vehicle, said apparatus comprising:
an engine controller adapted to:
determine that the engine oil condition may be detrimental at a current engine speed; and
reduce the engine speed by a predetermined amount if it is determined that the engine oil condition may be detrimental at the current engine speed.

13. The apparatus of claim 12, wherein the oil condition is high oil temperature and the apparatus further comprises an oil temperature sensor connected to the engine controller, said engine controller inputting the oil temperature from the oil temperature sensor.

14. The apparatus of claim 13, wherein the controller reduces the engine speed by:
determining a redline RPM offset based on the oil temperature; and
subtracting the redline RPM offset from a redline RPM limit for the engine.

15. The apparatus of claim 13, wherein the engine controller reduces the engine speed by determining a new redline RPM offset limit based on the oil temperature.

16. The apparatus of claim 12, wherein the oil condition is low oil pressure and the apparatus further comprises an oil pressure sensor connected to the engine controller, said engine controller inputting the oil pressure from the oil pressure sensor.

17. The apparatus of claim 16, wherein the engine controller reduces the engine speed by:
determining a redline RPM offset based on the oil pressure; and
subtracting the redline RPM offset from a redline RPM limit for the engine.

18. The apparatus of claim 16, wherein the engine controller reduces the engine speed by determining a new redline RPM offset limit based on the oil pressure.

19. The apparatus of claim 12, wherein reducing the engine speed comprises adjusting an electronic throttle.

20. The apparatus of claim 12, wherein reducing the engine speed comprises cutting off fuel to the engine.
